(19) United States
(12) Patent Application Publication
(10) Pub. No.: US 2022/0141419 A1
(43) Pub. Date: May 5, 2022

(54) UNIVERSAL TELEMATICS AND STORAGE DEVICE FOR VEHICLE BASED CAMERA SYSTEMS

(71) Applicant: Philip Maeda, Torrance, CA (US)

(72) Inventor: Philip Maeda, Torrance, CA (US)

(73) Assignee: RYDEEN NORTH AMERICA INC., Torrance, CA (US)

(21) Appl. No.: 17/083,453

(22) Filed: Oct. 29, 2020

(51) Int. Cl. H04N 5/77; H04N 5/38; H04N 7/18; H04W 36/14; H04W 4/40; G07C 5/08

(52) U.S. Cl. CPC H04N 5/77; H04N 5/38; H04N 7/183; H04W 84/12; H04W 4/40; G07C 5/0891; H04W 36/14

(57) ABSTRACT

A system for remotely controlling the operation of a vehicle having a camera device via Wi-Fi or cellular networking.

### BACKGROUND OF THE INVENTION

### 1. Field of the Invention

The present invention relates to an external module that can be connected to vehicle based camera systems that others enhanced storage capabilities for the extended recording as well as the capability for the transmission of images, video and sounds via radio frequency over available networks such as Wi-Fi or cellular networks.

### 2. Description of the Prior Art

For many years and with increasing proliferation in the marketplace, dash and security related cameras have been installed in vehicles. They are used to document driving conditions, conditions when the vehicle is parked but primarily for the visual documentation of accidents that may occur. They are often used in court and by insurance companies as they offer an unaltered record of events that have occurred while driving or parked and are often much more valuable or reliable then witness testimony. There are thousands if not millions oi these systems in use today by consumers and companies documenting the conditions prior to and during a traffic accident.

These pre-installed systems are all limited fa their operation by multiple factors. The first of these factors in limited storage space for the recording of video and images that are available within the devices. They often use memory cards or SD memory cards that have a limited capability and can only record higher definition video for a certain time limited to the capacity of the memory card. These systems often have very limited memory card sizes that can be used as they are produced without the highest quality in mind and price point is often the determining factor in their design. The way the manufacturers have gotten around this issue is to overwrite existing video files to make room for the new video being recorded. When this happens important video information could be lost and recorded over that could be needed by the driver at a later time. Storage capacity has always been an issue even with larger memory cards that may be used in better grade camera systems. With the emergence of HD, 1080-P and 4K video formats and high frame rates the file sizes of even a five-minute video segment would be extremely large and a long trip may be too much for the storage memory card to bold without overwriting what could be needed files.

The second problem with these systems is that they store all video, sound and images locally. The video of images would have to be removed from the camera system and transferred to a computer at a later time and sent or copied to be of any value. Camera systems with the ability to transmit images and video are now starting to appear on the market but an entire new system would need to be purchased. There is no way for preexisting systems to offer live video either on demand or automatically in case of a collision. The system could also be lost in the case of a collision or fire that may occur destroying the system and recording medium. In addition, there is no way for another party to take advantage of the images and video being recorded in real time. Examples of this could be a loved one checking in on a younger driver during a trip. They could see the route as well as the passengers within the vehicle in the cases of 360 degree or multiple camera systems. In a commercial application a dispatcher or manager could view the driver's route and be sure the driver is alert and obeying local and state law while on a brief trip or a long haul across country. This could include the driver's alert level, speed and route taken. This realtime information could be invaluable in both a consumer and commercial application.

What is desired is to provide a vehicle recording system that overcomes the above-noted disadvantages.

### SUMMARY Of THE INVENTION

The present invention focuses on an addition to new and pre-installed camera systems that will offer enhanced capabilities that would enable external recording and telematics functions so the upgrade these standard systems. This system connects via cable (and in some cases an adaptor) to the “slot” or memory card placement in the new or preexisting camera system. This would allow the transfer of information that was meant to be received by the memory card or storage medium to be used in other ways. The system when connected to the preexisting camera transfers the data received by the vehicle storage medium to a multi-function control unit acting like a router that can easily distribute that information where it can be used by the system. The system has two primary functions, the first is the enhanced storage capability of the memory unit and the second being a gateway for the transmission and remote storage of the images captured, either on demand or automatically.

In a first embodiment of the invention the unit acts as a router that would enhance the storage capability of any camera system. The unit would be connected to the card or memory slot of the existing or new camera by either direct connection in the form of a blank connected card or via adaptors that could be made to connect to all memory card styles and configurations. The data collected is transferred via cable to the main control unit. The main control unit has sufficient cable to extend to the desired location in the vehicle. It could be out in any open area or be hidden covertly so that the driver would not even know it was there. This position would also be more secure, than any windshield mounted solution in case of a collision and could even be encased and locked to restrict access to the unit. The main control unit takes the information from the camera and routes the information to limitless storage mediums including solid state hard drives of any size, any form of compact storage medium, all forms of USB storage including USB-C as well as traditional spinning drives and fully redundant memory systems. A buffer is incorporated to assist in the speed required for quick and accurate read, write capabilities. The central, or main control unit has options for the connection of all types of storage mediums and uses a data routing system that allows for all types of electronic storage medium as well as redundant storage capabilities. The memory controller also contains its own solid-state memory device or SSD to store files that have been marked important if a sensor in the camera has inducted a collision or a sensor triggered event and used on demand by the user or remote monitor. This adds significant improvements in the ability to store and secure large amounts of information locally that is also used by a second embodiment of the invention and referenced or transmitted cither live or from the memory storage from any remote location if needed. The system also incorporates a G or gravity sensor that could detect impacts sending these recorded files to the internal drive that stores these critical events that could not be accidently over written.

In the second embodiment, the same configuration and connection is made to the preexisting or new camera system. The unit is connected to the card or memory slot of the existing or new camera by either direct connection in the form of a blank connected card or via adaptors that could be made to connect to all memory card styles and configurations. The data collected is transferred via cable of a desired length to the main control unit. The main control unit has enough cable to extend to the desired location in the vehicle. The data from the camera system is then routed in the same manner to storage but, in addition, it is routed to a telematics transceiver that is installed either within the main control unit or externally using a wired connection. The telematics unit contains a cellular radio or modem that would be connected to any given cellular network. The network is used simultaneously with the on-board local recording of images and is available for on demand viewing for a five view as well as capable of referencing the storage medium for a view of any time period that had previously been recorded. The unit also records or sends data to cloud based servers that could store the data while the vehicle is running or not. Once the data is converted and sent through the cellular network and sent to a specific IP address, numerous addresses or to any and all cloud-based solutions that would be desired. The main control unit is also equipped with a GPS module so that time, speed and the route of the vehicle can be monitored independently or imbedded within the video files being stored. The telematics unit also contains a Wi-Fi transceiver that acts in the same manner as the cellular connection but used within a given area locally to reduce the cost of cellular service when not needed. The Wi-Fi radio is capable of two-way operation so that the unit can receive commands and index files needed as well as receiving both realtime and recorded video for instant playback and storage. This can be done with a mobile application that allows files to be downloaded via wi-fi to the user's phone. This is useful for instant viewing and posting video images on social media for situations that could occur while driving or parked. It can also be used if the installed camera does not have a built-in display for viewing real-time or recorded files.

The Wi-Fi system can also be used to relay recorded images automatically when connected to a home or business Wi-Fi system. The system is paired with a known, secured Wi-Fi network and upon returning from a trip or route driven can automatically sense and connect to the known network. Once a connection has been made with a secure network, commands or automatic programs are enabled. For instance, upon returning the unit would automatically connect to the known Wi-Fi network. When the system sees the ignition turned off, it starts transferring the data and video from the day or route taken to a local computer network for sale storage or analysis. This would not require any interaction from the driver or the receiving party to retrieve the data automatically. This is particularly useful in a commercial application; for example when a work truck or courier returns to a central hub or area where the vehicles are parked, all the video footage and data can be transferred via Wi-Fi to a central computer with no interaction from the driver. This can be stored, cataloged and can be used as needed for accidents, insurance claims and driver analytics.

The system allows a user to update or enhance any camera system with unlimited storage that could be protected from being altered or destroyed and adds Use safety and conveniences for a local broadcasted solution via Wi-Fi or for worldwide broadcast through data and cellular networks. Because the unit is equipped with a cellular radio it can also be utilized to receive commands as well, these commands from a remote user include actions pertaining to the viewings capture and storage of images, video file, location and data. The system also is used to send commands to the installed vehicle, the commands being in digital or analog formats and includes items such as lock, unlock, trunk release, start and other actions the user would deem necessary. These commands also includes an interface that is connected directly to the central access network (CAN) of the vehicle collecting data from the vehicle that could be stored internally or on any of the attached storage mediums. The unit also gives commands directly to the vehicle via the CAN network and interface. A serial connection is included to enable future control features to be available to the user.

The data that is collected from the system can also be utilized for maps, changing road and construction notifications and traffic awareness to be used as desired by the end user, client or commercial application. When the device is connected to a cloud based system it scans and analyzes the recorded video files to configure a recording pattern and adapt and optimize video for playback on the application indexing images by time, date, location or even known landscape and terrain.

### DESCRIPTION OF THE DRAWINGS

For a better understanding of the present invention as well as other objects and further features thereof, reference is made to the following description which is to be read in conjunction with the accompanying drawing therein:

FIG. 1 is a diagram of the basic components of the present invention;

FIG. 2 illustrates the main connector and wiring for the system of the present invention; and

FIG. 3 illustrates a block diagram of the system of the present invention.

### DESCRIPTION OT THE INVENTION

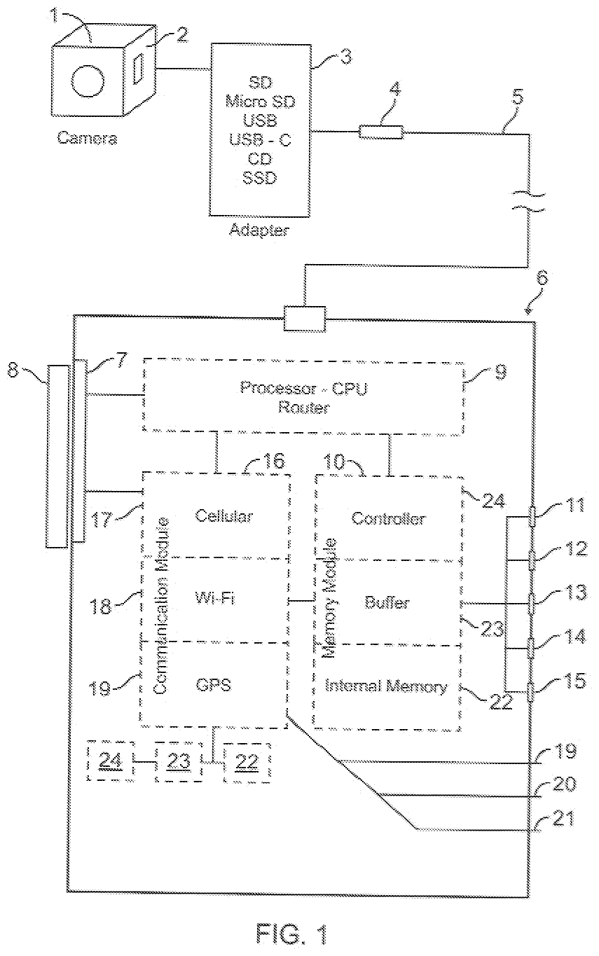

FIG. 1 illustrates the basic components of the present invention. The pre-installed or simple dash camera (1) with internal memory card slot (2) is connected to one of the many adaptors (3) that are be inserted instead of the traditional memory card. The adaptors provided include SD, Micro SD, USB, USB-C, Compact flash and serial connection. The selected adaptor is connected to the adaptor housing (4) and connected to the main unit (6) via cable (5). The main unit (6) can be located anywhere desired and can be hidden or secured in a locking container. The main unit (6) contains all of the systems required and has a primary connector socket (7) that is connected to the main harness (8) with wires connected to the vehicle. The wire harness (8) has all of the wires needed to operate the units. It includes the following components:

### 12 Volt+Power

System ground
ACC or accessory power
Output for locking of the doors
Output for Unlocking of the doors
Output for Trunk release
Aux Output for any item need or to trigger a start condition
A CAN connection, if needed, to the vehicle
A serial connection
The cable (5) from the camera (1) enters Use main unit (6) and connects to the main processor or CPU (9). The CPU (9) contains a processor that controls all aspects of the system. The processor controls a router that will facilitate the transfer of data and images to both the memory controller (10) as well as the telematics module (16). The processor (9) processes needed data and images that will be stored in the memory control module (10). The memory control module is equipped with a holler (23) to facilitate the transfer of data, images and video to the available storage devices. The memory control module (10) has an internal memory (22) that can be used in any manner needed by the user. It houses critical files which cannot be overwritten. The memory control module (10) sends and receives video to and from the available storage devices. A number of devices can be connected to allow for a wide range of options as well as the ability to read and write to more them one medium at a time for redundancy. The main unit (6) has connection points for an SD card or micro SD card (11), a SSD (solid stale drive) connection (12), a USB connection (13), a USB-C connection (14) and a serial controller connection (15). The controller (10) stores the: needed data of video and images and will be able to read, write files and categorize the file with names that include attributes that can be searched or cataloged later. The main processor or controller (9) is also connected to the telematics module (16) which contains the radios for both near field and broadband communication. The telematics module (16) is comprised of several components or systems to allow the transmission and reception of data and images from both the live camera view as well as any and all of the recording mediums in rise memory module (10). The telematics module (16) also contains a cellular transceiver (17) that is connected to a cellular data network and is accessible by any internet connected device. It is used to send and receive data, images and video to any remote location or servers desired in a full cloud-based system. The cellular transceiver (17) is also be used to receive commands that would initiate actions within the system as well as the connected vehicle. The telematics module (16) also contains a Wi-Fi transceiver (18) that can be used in the same manner as the cellular transceiver when connected to a local secured Wi-Fi network. This can also be used by the driver connected with a phone application for retrieval of stored or live files. This application is also used to adjust the systems settings as need by the driver. The Wi-Fi system automatically connects to a secure Wi-Fi system when in range and download files specified when within range. The telematics modulo (16) also contains a GPS system (19) so the location of the vehicle, files recorded, speed and direction could be saved or imbedded within the video files. Telematics module (16) also contains internal GPS antenna (24), an internal cellular antenna (23) and an internal Wi-Fi antenna (22). The module also contains pons for external antennas (19), (20), (21) as needed.

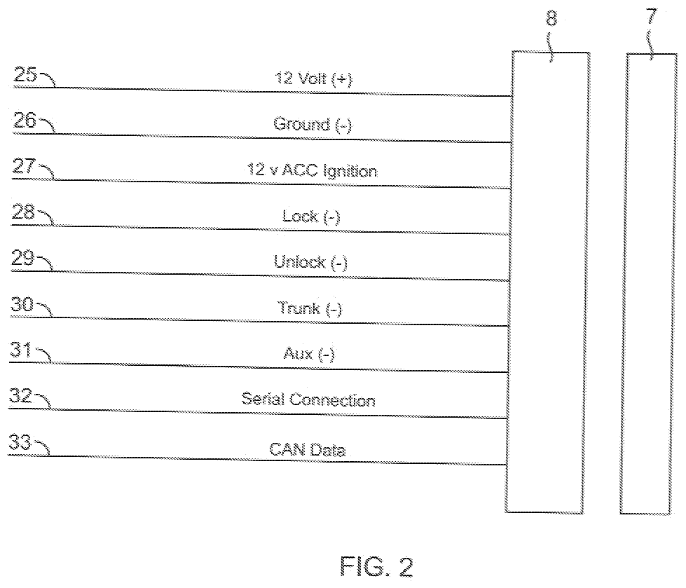

FIG. 2 describes the main wire harness and the connections available within the harness. The main unit (6) will require power and ground to operate. It is equipped with a main power connector socket (7) that is used in conjunction with the main wire harness connector (8). The connector contains eight wires that are connectable to additional features available within the system. The first three wires (25), (26), and (22) are needed for system operation, but the others can be connected if desired. The connector (8) powers the unit with the first wire in the harness being a 12-volt power input (25). The second wire needed is a system ground (26). The next wire is the ACC or power with the ignition ON input (27). The remaining wires are for control of certain items that can be used to enhance the systems operation. The wire (28) can be an input, output for the locking of the doors of the vehicle. Since it is an IO, (input output), it also is used by the system to know when the vehicle doors are kicked. Wire (29) works in the same manner but is for Un-lock. Wire (30) can be used for a trunk release or to trigger another action in the vehicle. Wire 30 is an auxiliary output that can be used as desired to trigger any event for the driver. The connector also contains a serial connection (31) that can be used in conjunction with any serial communication device needed for special circumstances. The connector (8) also contains a CAN output (33) for the direct connection to the central access network of the vehicle.

The wire harness connection to the vehicle provides inputs and outputs needed for the operation of the unit. The main connector comprises a female side (7) that is attached to the main unit (6) as shown in FIG. 1 and is a part of the main unit circuit board. The mating male connector (8) houses the wiring needed for the vehicle connections. The wiring of the connector is as follows:
The power wire (25) provides the power needed for the system. The system requires 12-24 positive volts DC to operate. This wire will be monitored for current draw when the vehicle is not being driven to ensure power saving measures can be implemented when the vehicle is not being operated for long periods of time.
The ground wire (26) provides a stable chassis (-) ground for the system. It will be connected to the battery ground or frame ground of the vehicle.
12-24 Volt positive connection when the vehicle ignition is in the ON position (27) will allow the system to know when the vehicle is in use and will process information, images and video in a vehicle running mode.
Connection (28) is an input and output for the locking of the doors by way of the telematics module that can be controlled by any internet enabled system. It will act as an output for the remote locking of the vehicle but can also be used by the system as an input that can read the door lock status from the vehicle. This can be a positive or negative signal,
Connection (29) operates in the same manner as (28) but for the Un-Lock function of the door kicking system,
Connection (30) is an output for a trunk release of the vehicle that can be activated only when the ignition status is in the OFF position. It can also be a positive or negative pulsed output.
Connection (31) is an auxiliary output that can be pulsed, timed, ON or OFF depending on the use intended, it am be used for any purpose deemed necessary by the end user of the vehicle, it is programmable to be used in a wide array of applications.
Connection (32) is a serial connection that can be programmed internally and can interface with any future serial controlled devise.
Connection (33) is a two wire CAN (Central Access Network) control system. It composes a CAN High and CAN Low wire that is directly attached to the CAN system of the vehicle for vehicle control and vehicle information gathering. It also gathers needed information such as speed, RPM, on brand vehicle systems and status of the vehicle systems and is used to push commands to the vehicle such as not lock, unlock, start, climate and lighting controls.

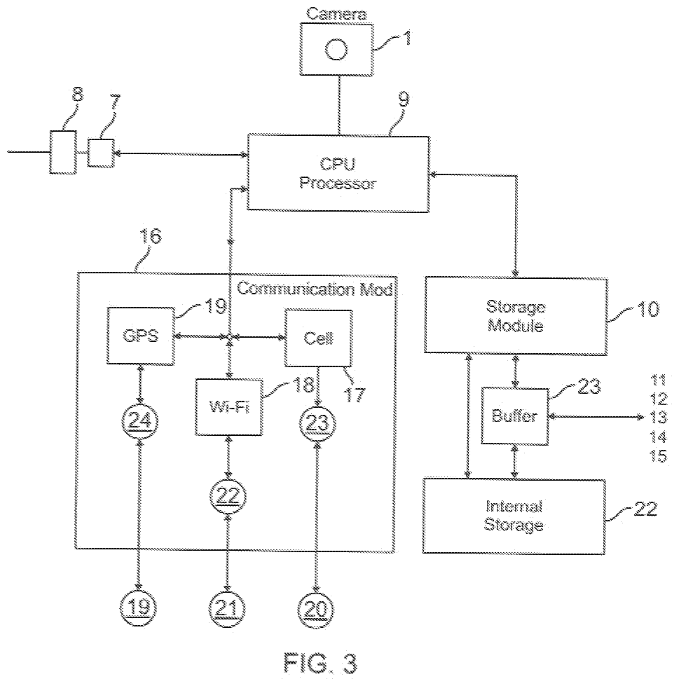

FIG. 3 is a simplified block diagram of the complete system and its operating configuration. These systems are all housed within a single unit for ease of installation and concealment of the system. The system can be broken up in three segments. The CPU, or main processor, (9), the memory module (10) and the telematics module (16).

The main processor (9) is directly connected to the memory output of a new vehicle or any added camera system (1) with local save only features. The main processor (9) contains all of the logic and processor and router systems needed for the control of both the storage module (10) as well as the telematics module (16) and the interactions of all of the units. The storage module (19) has its own processor as well as a buffer (23) for the smooth recording and playback of data and video images. The memory module (10) has the capability to catalog or index video segments based on time or a numbered system for ease of playback search for needed files. Module (10) has its own built in memory (22) for the storage of critical files such as a triggered event or accident; these files are protected and not overwritten. The buffer (23) connects directly to all of the external storage devices 11-15 that can be used by the client as needed. It distributes and records files to these available external storage sources and well as play back of the files locally or by way of Wi-Fi (18) or cellular service (17) contained within the telematics (or communication module) (19).

The processor module (9) also connects and controls the communications module (16) and contains all of the needed systems, to allow remote viewing of live and recorded files: through various communication systems. It also allows incoming commands either from an application on the user s phone or any internet or locally connected system. The communication module (16) contains three systems that all work together and are controlled by the main processor (9). These systems includes GPS Module (19) for the accurate speed and location of the vehicle being monitored, an internal GPS antenna (24) and a connection for an external GPS antenna (19) for a more covert mounting location. The GPS information can be monitored remotely and if needed added to the video files being recorded. The communication module (16) is also equipped with a cellular radio (17) that is capable of being connected to worldwide cellular systems. This allows for the remote viewing of files from any locution that is covered by a cellular system. It can be accessed by a mobile phone application as well as any internet connected device and used to send commands to the vehicle to control various options such as to lock, unlock, start and access various information from the vehicle. It contains a built-in cellular antenna (23) as well as an output for an external antenna if needed (20). The communication module (16) enables all aspects of the system to be communicated to any external internet connected system including cloud-based servers accessible to the user and can be used to store all information needed for any period of time. The communication module (16) also contain a Wi-Fi radio transceiver (18) that behaves in the same manner as the cellular radio but withing range of any known Wi-Fi network. This reduces the need associated with the higher cost related to cellular data. The Wi-Fi transceiver can also be programmed to connect to a known network and transfer all data automatically when within range or at any scheduled time as well as on demand. The Wi-Fi radio (18) has a built-in antenna (22) as well as a connection for an external antenna (21) if needed. The main processor (9) is connected to the vehicle by way of the main connector (7) and (8).

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. A system added or connected to an existing vehicle camera system having local a storage card interface or USB connection, the existing camera system not having the capability of being viewed remotely, the added system providing additional storage to said vehicle camera system and the capability for remotely viewing and controlling vehicle functions within said vehicle using Wi-Fi or a cellular modem network including recording images, said additional storage not including the cloud.

2-5. (canceled)

6. The system of claim 1 wherein data from said vehicle camera system is automatically transferred to a secured Wi-Fi or cellular network when the vehicle is both in range and inoperative.
